(19) United States
(12) Patent Application Publication
(10) Pub. No.: US 2013/0159526 A1
(43) Pub. Date: Jun. 20, 2013

(54) Method of handling access control information and related communication device

(71) Applicant: HTC Corporation, Taoyuan County (TW)

(72) Inventors: Chun-Ta Yu, Taoyuan County (TW); Yin-Yeh Tseng, Taoyuan County (TW)

(73) Assignee: HTC CORPORATION, Taoyuan County (TW)

(21) Appl. No.: 13/721,061

(22) Filed: Dec. 20, 2012

Related U.S. Application Data
(60) Provisional application No. 61/577,674, filed on Dec. 20, 2011.

(51) Int. Cl. H04L 29/06

(52) U.S. Cl. CPC H04L 29/06
USPC 709/225

(57) ABSTRACT

A method of handling access control information of a management object in a device management (DM) client of a service system is disclosed. The method comprises creating a management tree for storing the access control information of the management object; arranging a first node in the management tree, for storing an identifier of the management object; arranging a second node in the management tree, for storing an identifier of a DM server of the service system; arranging a third node in the management tree, for storing a path of a node in the management object; and arranging a fourth node in the management tree, for storing access right of the DM server related to the node.

### CROSS REFERENCE TO RELATED APPLICATIONS

This application claims the benefit of U.S. Provisional Application No. 61/577,674, filed on Dec. 20, 2011 and entitled “Converting method for access control system in OMA Device Management”, the contents of which are incorporated herein in their entirety.

### BACKGROUND OF THE INVENTION

1. Field of the Invention

The present invention relates to a method used in a service system and related communication device, and more particularly, to a method of handling access control information and related communication device.

2. Description of the Prior Art

Open Mobile Alliance (OMA) is founded to develop OMA specifications for mobile services to meet users' needs. Furthermore, the OMA specifications aim to facilitate providing of the mobile services which are interoperable across geographic areas (e.g. countries), operators, service providers, networks, operation systems and mobile devices. In detail, the mobile services conforming to the OMA specifications can be used by the users without being restricted to particular operators and service providers. The mobile services conforming to the OMA specifications are also bearer agnostic, i.e., the bearer that carries the mobile services can be a second generation (2G) mobile system such as Global System for Mobile Communications (GSM), Enhanced Data rates for GSM Evolution (EDGE) or General Packet Radio Service (GPRS), or a third generation (3G) and beyond mobile system such as Universal Mobile Telecommunications System (UMTS), Long Term Evolution (LTE) or LTE-Advanced (LTE-A). Further, the mobile services conforming to the OMA specifications can be executed on various operation systems such as Windows, Android or Linux operated on various mobile devices. Therefore, industries providing the mobile devices or the mobile services supporting the OMA specifications can benefit from a largely growing market enabled by interoperability of the mobile services. Besides, the users use the mobile devices or the mobile services supporting the OMA specifications can also have a better experience due to the interoperability of the mobile services.

In OMA Device Management (DM) requirement, a DM server is defined as an authorized legal entity which can manage one or more DM clients (e.g. mobile devices) by using a DM protocol (e.g., DM protocol 1.x, DM protocol 2.0, or later versions) conforming to the OMA specifications. In detail, the DM protocol defines a way according to which a packet, a message and/or a package (i.e., a combination of multiple messages transmitted in a same direction) is exchanged between the DM server and the DM client. The DM protocol also defines a way according to which the DM client can feedback a command, a status or a report to the DM server. Further, when using the DM protocol, the DM server manages the DM client through a set of management objects (MOs) in the DM client, wherein each management object may include one or more nodes. A management object may be small as an integer or large as a picture. Besides, the management object may conform to the DM protocol such as a Software Component Management Object (SCOMO), a Software and Application Control Management Object (SACMO) or a Firmware Update Management Object (FUMO).

In the DM protocol 1.x, an access control list (ACL) of a node (e.g., an interior node or a leaf node) is used for listing DM servers having one or more access rights of the node. In detail, there are five access rights: Add, Delete, Replace, Exec and Get which correspond to an Add command, a Delete command, a Replace command, an Exec command and a Get command (i.e., DM commands), respectively. For example, a DM server having an access right of Get for a node can retrieve (i.e., get) content of the node. The content of the node can be data (e.g., value) of the node when the node is a leaf node, or can be a child list of the node when the node is an interior node. In certain situations, except the content of the node, a DM server with the access right of Get may also retrieve the ACL of the node. A method according to which the DM server retrieves the ACL is similar to the above description, and is not narrated herein. Thus, a node-level ACL can be provided by the DM protocol 1.x.

However, the DM protocol 2.0 is developed to provide a MO-level ACL. In detail, if a DM server has an access right for a management object, the DM server has the access right for all nodes in the management object. When a new management object is added in a DM client conforming to the DM protocol 2.0, only the MO-level ACL can be added for the management object. Besides, when a DM client conforming to the DM protocol 1.x is (or to be) upgraded to the DM client conforming to the DM protocol 2.0, the DM client can not keep (i.e., maintain) original ACLs in the DM client due to inconsistency between the node-level ACL and the MO-level ACL. As a result, the original ACLs may be ignored or deleted, and the management object including the nodes therein can not be properly managed or controlled. Thus, converting original access control information created according to the DM protocol 1.x to new access control information conforming to the DM protocol 2.0 (i.e., generating the new access control information according to the original access control information) is a topic to discussed and addressed.

### SUMMARY OF THE INVENTION

The present invention therefore provides a method and related communication device for handling access control information to solve the abovementioned problem.

A method of handling access control information of a management object in a device management (DM) client of a service system is disclosed. The method comprises creating a management tree for storing the access control information of the management object; arranging a first node in the management tree, for storing an identifier of the management object; arranging a second node in the management tree, for storing an identifier of a DM server of the service system; arranging a third node in the management tree, for storing a path of a node in the management object; and arranging a fourth node in the management tree, for storing access right of the DM server related to the node.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a service system according to an example of the present invention.

FIG. 2 is a schematic diagram of a communication device according to an example of the present invention.

FIG. 3 is a flowchart of a process according to an example of the present invention.

FIG. 4 is a schematic diagram of generating access control information according to an example of the present invention.

### DETAILED DESCRIPTION

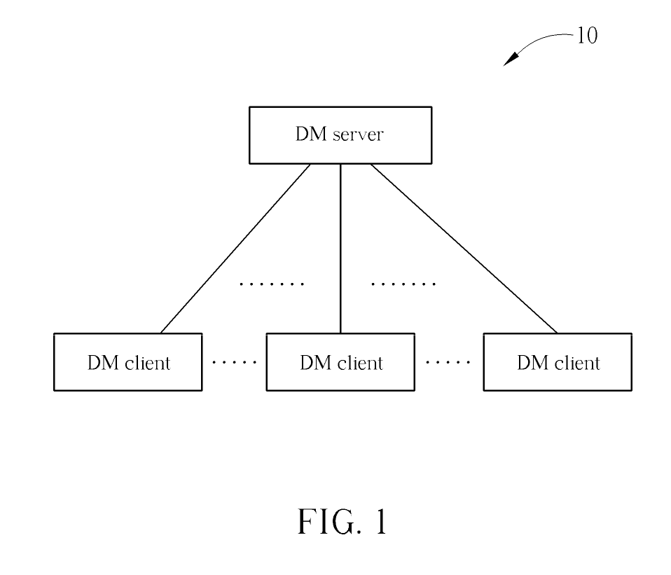

Please refer to FIG. 1, which is a schematic diagram of a service system 10 according to an example of the present invention. The service system 10 is briefly composed of a device management (DM) server and a plurality of DM clients supporting the DM protocol 1.x, the DM protocol 2.0 or later versions developed by Open Mobile Alliance (OMA). ADM client maintains access control list(s) (ACL(s)) which comprises access rights corresponding to one or more DM servers. The access rights may be related to management objects in the DM client, or may be related to nodes (e.g., an interior node and/or a leaf node) in the management object. In detail, when a DM server intends to execute a DM command on a node in the management object in the DM client, the DM client determines whether the execution is allowed (i.e., valid) according to the access rights in the ACL. The DM command may be any one of an Add command, a Delete command, a Replace command, an Exec command or a Get command corresponding to the access rights of Add, Delete, Replace, Exec and Get, respectively. The DM server can execute the DM command on the node if the DM server has the access right of the DM command for the node. For example, the DM server can perform the Add command on an interior node, if the DM server has the access right of Add for the interior node.

In FIG. 1, the DM clients and the DM server are simply utilized for illustrating a structure of the service system 10. Practically, the DM clients can be installed in desktops and home electronics which are fixed at a certain position. Alternatively, the DM clients can be installed in mobile devices such as mobile phones, laptops, tablet computers, electronic books, and portable computer systems. The service system can be bearer agnostic, i.e., the bearer used for exchanging information (e.g., message, request, response, package, etc.) between the DM clients and the DM server can be a second generation (2G) mobile system such as Global System for Mobile Communications (GSM), Enhanced Data rates for GSM Evolution (EDGE) or General Packet Radio Service (GPRS), a third generation (3G) and beyond mobile system such as Universal Mobile Telecommunications System (UMTS), Long Term Evolution (LTE) system or LTE-Advanced (LTE-A) system, or even a wireline communication system such as an Asymmetric Digital Subscriber Line (ADSL).

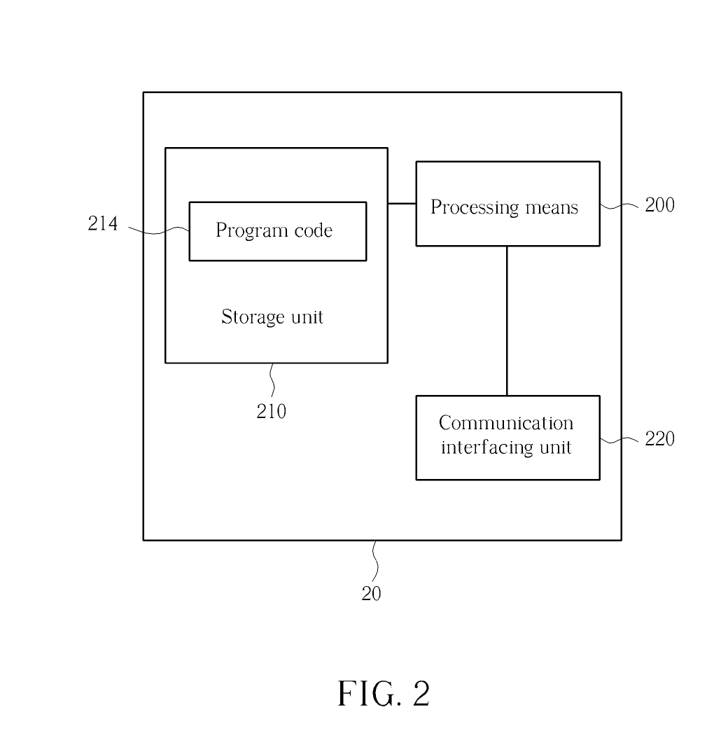

Please refer to FIG. 2, which is a schematic diagram of a communication device 20 according to an example of the present invention. The communication device 20 can be devices wherein a DM client or the DM server shown in FIG. 1 is installed. The communication device 20 may include a processing means 200 such as a microprocessor or an Application Specific Integrated Circuit (ASIC), a storage unit 210 and a communication interfacing unit 220. The storage unit 210 may be any (non-transitory) computer-readable storage medium that can store a program code 214, accessed by the processing means 200. Examples of the storage unit 210 include but are not limited to a subscriber identity module (SIM), read-only memory (ROM), flash memory, random-access memory (RAM), CD-ROM/DVD-ROM, magnetic tape, hard disk, and optical data storage device. The communication interfacing unit 220 is preferably a transceiver, and can transmit/receive information (e.g., message, request, response, package, etc.) according to processing results of the processing means 200.

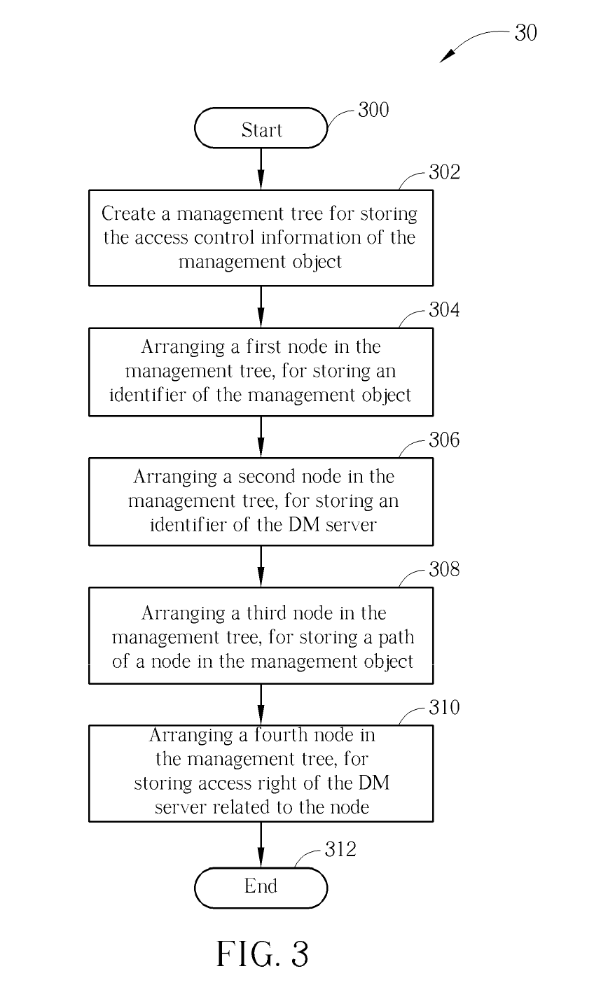

Please refer to FIG. 3, which is a flowchart of a process 30 according to an example of the present invention. The process 30 is utilized in the service system 10, i.e., the DM clients and/or the DM server shown in FIG. 1, for handling access control information (e.g., access control list(s)) of a management object in a DM client. The process 30 may be compiled into the program code 214 and includes the following steps:

Step 300: Start.

Step 302: Create a management tree for storing the access control information of the management object.

Step 304: Arranging a first node in the management tree, for storing an identifier of the management object.

Step 306: Arranging a second node in the management tree, for storing an identifier of the DM server.

Step 308: Arranging a third node in the management tree, for storing a path of a node in the management object.

Step 310: Arranging a fourth node in the management tree, for storing access right of the DM server related to the node.

Step 312: End.

According to the process 30, after a management tree is created for storing the access control information of the management object, a first node is arranged (i.e., created) in the management tree for storing an identifier of the management object, a second node is arranged in the management tree for storing an identifier of the DM server, a third node is created in the management tree for storing a path of anode in the management object, and a fourth node is created in the management tree for storing access right of the DM server related to the node. In other words, even though the DM protocol of the DM client may be upgraded from 1.x to 2.0, original access control information created according to the DM protocol 1.x can be kept (i.e., converted) via adding two nodes for the path and the access right. That is, the management tree is created according to the DM protocol 2.0 or later versions, for storing the access control information created according to the DM protocol 1.x. Thus, the original access control information is kept, and the management object including the nodes therein can be properly managed.

Please note that, a method according to which the DM client uses the management tree is not limited. For example, after receiving a message transmitted by a DM server (e.g., the DM server with/without the access right) of the service system, the DM client determines whether a path in the message is valid according the path in the third node (e.g., point to the same node). If the DM client determines that the path in the message is not valid (e.g., point to different nodes), the DM client can discard or reject the message. Alternatively, if the DM client determines that the path in the message is valid (e.g., point to the same node), the DM client continues to determine whether to grant a DM command in the message according to the access right in the fourth node. That is, the DM client determines whether to grant the DM command by checking the DM command and the access right in the fourth node. If behavior of the DM command is the same as the access right in the fourth node (e.g., Get command and read access right), the DM client allows the DM command in the message to be executed on the node. Otherwise, the DM client can reject the message. Thus, the DM client can grant the DM command to the DM server, after the above checks are completed successfully. The access right is a control right related to a DM command. For example, when the access right includes the DM command and an identifier of the DM server with the access right, e.g., “Get=DM server ID”, the DM client grants the DM command in the message. In another example, when the access right includes the DM command, e.g., “Get”, the DM client grants the DM command in the message. Alternatively, when the access right is related to the DM command, e.g., “Read”, the DM client grants the DM command to read in the message.

In another example, after receiving a message transmitted by a DM server (e.g., the DM server with/without the access right) of the service system, the DM client determines whether an identifier of a management object (which may not be the management object described by the management tree) corresponding to (i.e., indicated by) a path in the message is valid according the identifier in the first node (e.g., whether the identifiers of the management objects are the same). If the DM client determines that the identifier of the management object indicated by the path in the message is not valid (e.g., the identifiers are different), the DM client can discard or reject the message. Alternatively, if the DM client determines that the identifier of the management object indicated by the path in the message is valid (e.g., the identifiers are the same), the DM client continues to determine whether an identifier of the DM server transmitting the message is valid according to the identifier in the second node (e.g., whether the identifiers of the DM servers are the same). If the DM client determines that the identifier of the DM server transmitting the message is not valid (e.g., the identifiers are different), the DM client can discard or reject the message. Alternatively, if the DM client determines that the identifier of the DM server transmitting the message is valid (e.g., the identifiers are the same), the DM client continues to determine whether a path in the message is valid according the path in the third node (e.g., point to the same node). If the DM client determines that the path in the message is not valid (e.g., point to different nodes), the DM client can discard or reject the message. Alternatively, if the DM client determines that the path in the message is valid (e.g., point to the same node), the DM client continues to determine whether to grant a DM command in the message according to the access right in the fourth node. That is, the DM client determines whether to grant the DM command by checking the DM command and the access right in the fourth node. If behavior of the DM command is the same as the access right in the fourth node (e.g., Get command and read access right), the DM client allows the DM command in the message to be executed on the node. Otherwise, the DM client can reject the message. Thus, the DM client can grant the DM command to the DM server, after the above checks are completed successfully.

Please note that, in the above examples, the message is rejected after determining one of the checks is not valid. However, this is not a restriction, and the DM client can check the message according to a MO-level ACL described according to the DM protocol 2.0 after determining one of the checks is not valid, to see if the message is valid according to the MO-level ACL. That is, the DM client still grants the DM command to the DM server, after determining that the message is valid according to the MO-level ACL. The DM client discards or rejects the message, after determining that the message is not valid according to the MO-level ACL. Alternatively, the DM client can check the message according to the MO-level ACL, before checking the message according to a node-level ACL, i.e., before proceeding the above examples (i.e., checking the four nodes). In other words, the DM client proceeds the above examples (i.e., checking the four nodes), after determining the message is not valid according to the MO-level ACL. The DM client does not proceed the above examples and grants the DM command to the DM server, after determining the message is valid according to the MO-level ACL.

On the other hand, a time at which the management tree and the nodes therein (i.e., the four nodes) are created is not limited. For example, the management tree and the nodes therein can be created, when the DM client is upgraded from the DM protocol 1.x to the DM protocol 2.0. Besides, the management tree and the nodes therein can be first created by a DM server (e.g., the DM server with the access right), and is then transmitted to the DM client. Alternatively, the management tree and the nodes therein can be created by the DM client itself.

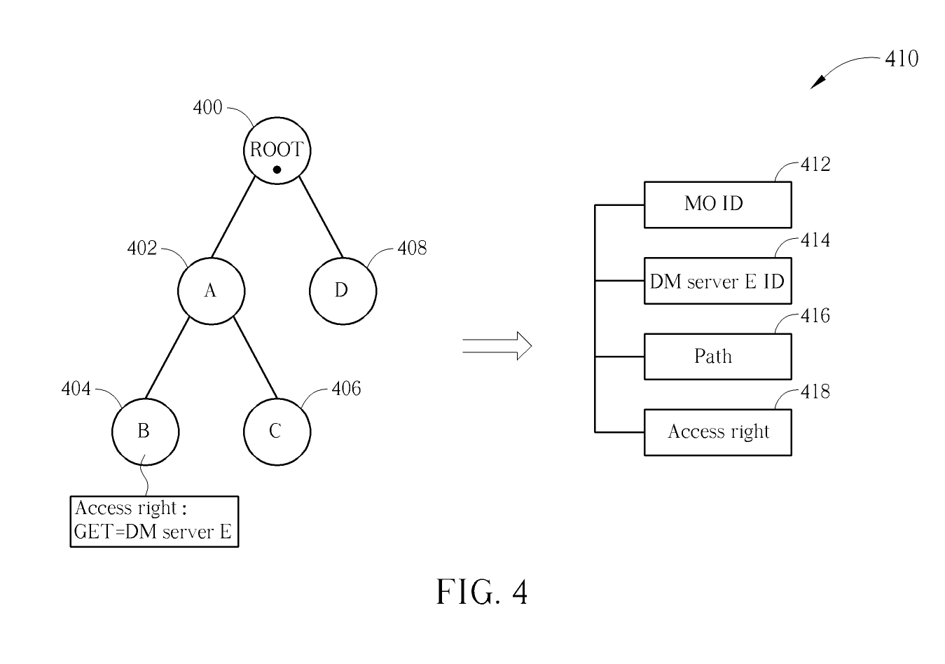

Please refer to FIG. 4, which is a schematic diagram of generating access control information according to an example of the present invention. As shown in the left-hand side of FIG. 4, 4 nodes coupled to a root 400 include a node A 402, a B node 404, a C node 406 and a D node 408, and are stored in a DM client. The nodes 402-406 are in (i.e., belong to) a same management object. The B node 404 may be accessed or controlled by a DM server E according to access control information (e.g., access control list) of the B node 404, e.g., “Get=DM server E” or “Get=DM server E ID”. Thus, a management tree 410 can be created for the management object according to the process 30, as shown in the right-hand side of FIG. 4, wherein the management tree 410 includes 4 nodes 412-418 for storing the access control information. In detail, an identifier (e.g., MO ID) of the management object is stored in the node 412, an identifier (e.g., DM server E ID) of the DM server E is stored in the node 414, a path (e.g., ./A/B) of the B node 404 is stored in the node 416, and an access right (e.g., “Get=DM server E” or “Get=DM server E ID”) of the DM server E related to the B node 404 is stored in the node 418. Thus, the access control information which is anode-level information created according to the DM protocol 1.x can be processed, when the DM protocol of the DM client is upgraded from 1.x to 2.0.

Those skilled in the art should readily make combinations, modifications and/or alterations on the abovementioned examples. The abovementioned steps of the processes including suggested steps can be realized by means that could be a hardware, a firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include a system on chip (SOC), system in package (SiP), a computer on module (COM), and the communication device 20.

To sum up, the present invention provides a method for handling access control information for a management object in a DM client. According to the present invention, original access control information created for the management object (and/or nodes therein) according to the DM protocol 1.x can be converted to new access control information conforming to the DM protocol 2.0. As a result, the original access control information is kept, and the management object and the nodes therein can be properly managed after the DM protocol of the DM client is upgraded from 1.x to 2.0.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of handling access control information of a first management object in a device management (DM) client of a service system, the method comprising:
creating a management tree for storing the access control information of the first management object;
arranging a first node in the management tree, for storing an identifier of the first management object;
arranging a second node in the management tree, for storing an identifier of a first DM server of the service system;
arranging a third node in the management tree, for storing a path of a node in the first management object; and
arranging a fourth node in the management tree, for storing access right of the first DM server related to the node.

2. The method of claim 1, wherein after receiving a message transmitted by a second DM server of the service system, the DM client determines whether a path in the message is valid according to the path in the third node.

3. The method of claim 2, wherein the DM client determines whether to grant a DM command in the message according to the access right in the fourth node after determining that the path is valid, and the DM client rejects the message after determining that the message is not valid.

4. The method of claim 3, wherein when the access right comprises the DM command and an identifier of the second DM server, the DM client grants the DM command in the message.

5. The method of claim 1, wherein after receiving a message transmitted by a second DM server of the service system, the DM client determines whether an identifier of a second management object corresponding to a path in the message is valid according to the identifier in the first node.

6. The method of claim 5, wherein the DM client determines whether an identifier of the second DM server is valid according to the identifier in the second node after determining that the identifier of the second management object is valid, and the DM client rejects the message after determining that the identifier of the second management object is not valid.

7. The method of claim 6, wherein the DM client determines whether the path in the message is valid according to the path in the third node after determining that the identifier of the second server is valid, and the DM client rejects the message after determining that the identifier of the second server is not valid.

8. The method of claim 7, wherein the DM client determines whether to grant a DM command in the message according to the access right in the fourth node after determining that the path in the message is valid, and the DM client rejects the message after determining that the path in the message is not valid.

9. The method of claim 8, wherein the DM client grants the DM command if behavior of the DM command is the same as the access right in the fourth node, and the DM client rejects the message if the behavior of the DM command is not the same as the access right in the fourth node.

10. The method of claim 9, wherein the DM client determines whether the message is valid according to management object (MO)-level access right of the first management object described according to the DM protocol 2.0, before rejecting the message.

11. The method of claim 5, wherein the DM client starts to check the identifier of the second management object after determining that the message is not valid according to MO-level access right of the first management object described according to the DM protocol 2.0, and the DM client does not start to check the identifier of the second management object and grants a DM command in the message after determining that the message is valid according to the MO-level access right.

12. The method of claim 1, wherein the management tree and the four nodes are created, when the DM client is upgraded from the DM protocol 1.x to the DM protocol 2.0.

13. The method of claim 1, wherein the management tree and the four nodes are created by the first DM server, and are transmitted to the DM client.

14. The method of claim 1, wherein the management tree and the four nodes are created by the DM client.

15. The method of claim 1, wherein the management tree and the four nodes are created according to the DM protocol 2.0 or later versions, for storing the access control information created according to the DM protocol 1.x.
